(19) United States
(12) Patent Application Publication
(10) Pub. No.: US 2024/0044073 A1
(43) Pub. Date: Feb. 8, 2024

(54) LAYER COMPOSITE FOR USE AS AN IMITATION LEATHER

(71) Applicant: NUVI RELEAF GmbH, Fernwald (DE)

(72) Inventors: Andreas RÖßLER, Fernwald (DE); Nina RÖßLER, Fernwald (DE)

(73) Assignee: NUVI RELEAF GmbH, Fernwald (DE)

(21) Appl. No.: 18/286,301

(22) PCT Filed: Apr. 12, 2022
(86) PCT No.: PCT/EP2022/059744

§ 371 Date: Oct. 10, 2023

(30) Foreign Application Priority Data
Apr. 12, 2021 (DE) 10 2021 109 087.3

(51) Int. Cl. D06N 3/00; D06N 3/12; D06N 3/18; B32B 5/02; B32B 27/12; B32B 27/32; B32B 27/36; B32B 27/40; B32B 27/34; B32B 27/20; D06Q 1/10

(52) U.S. Cl. CPC D06N 3/0061; D06N 3/0011; D06N 3/0006; D06N 3/0009; D06N 3/0015; D06N 3/0063; D06N 3/0077; D06N 3/0088; D06N 3/12; D06N 3/183; B32B 5/022; B32B 5/024; B32B 5/026; B32B 27/12; B32B 27/32; B32B 27/36; B32B 27/40; B32B 27/34; B32B 27/20; D06Q 1/10; D06N 2201/045; D06N 2203/024; D06N 2205/023; D06N 2209/14; D06N 2211/10; D06N 2211/28; B32B 2262/065; B32B 2255/02; B32B 2255/26; B32B 2270/00; B32B 2451/00; B32B 2437/00

(57) ABSTRACT

A layer composite for use as an imitation leather is provided. Also provided is a garment including the layer composite and a method of manufacturing the layer composite.

### SUBJECT MATTER OF THE INVENTION

The invention relates to a layer composite for use as an imitation leather, a garment comprising the layer composite, and a method of making the layer composite.

### BACKGROUND OF THE INVENTION

The leather industry is one of the industries with a high potential for environmental pollution. The chemicals used in tanning, in particular antibiotics, tanning agents, biocides and volatile organic chemicals such as formaldehyde, can cause lasting damage to the environment if not used properly. However, a correspondingly proper use of the chemicals requires a high expenditure of time and money. In addition, some of the substances used may remain in the material and may be released during subsequent use. This poses health risks for the end customer. There are also ethical concerns about the use of animal skins.

There have for some time been efforts to replace leather with synthetically produced materials. Generally, these surrogates are called artificial leather. This is usually a composite of a textile base carrier and a plastic layer applied to it, such as polyvinyl chloride (PVC) or polyurethane (PU).

DE 1 635 546 A describes an artificial leather produced by means of papermaking methods, the artificial leather consisting essentially of non-fibrous elastomeric polyurethane with minor admixtures of staple fibres, preferably synthetic fibres or leather fibres.

DE 199 37 808 A1 relates to a leather substitute material having a substantially cloth-like carrier layer, a thinner barrier layer provided thereon and a cover layer provided on the barrier layer.

DE 10 2015 101 331 A1 relates to a translucent artificial leather with a textile support structure and with at least one layer of PU or PVC. The layer composite may further have a surface coating.

The artificial leathers obtained by these processes have some advantages over animal leather. PVC artificial leathers are inexpensive and robust, whereas PU artificial leathers have advantageous material properties such as repeated washability. Since artificial leather is a continuous material, cutting it to size is also much easier than with animal leather. The manufacturing process is also considerably shorter, as the time-consuming tanning process is eliminated. Furthermore, artificial leather manufacturers are not bound to the market availability of certain animal skins.

However, the previously known artificial leather materials are essentially based on synthetic plastics that are made from limited fossil resources such as petroleum and are not biodegradable. In addition, such artificial leather materials usually have solvent or dispersion agent residues and softeners and are therefore not completely harmless to health. Furthermore, the same visual and haptic properties can often not be achieved with artificial leather as with animal leather.

A number of the problems mentioned above are solved by the layer composite disclosed in EP 3 710 631 A1. This comprises a textile carrier layer, a cover layer and a decorative layer which comprises a plant leaf material and which is arranged between the carrier layer and the cover layer. However, the cover layer required for this layer composite leads to a reduced biodegradability of the artificial leather and thus lowers its sustainability. Furthermore, the application of a cover layer, which often consists of a synthetic polymer material, is associated with an additional work step and thus a more complex manufacturing process. Furthermore, the application range of the layer composite of EP 3 710 631 A1 is limited with respect to the properties to be achieved with a plant leaf material as a decorative layer. For example, light tones of colour of the leather can only be achieved with additional (artificial) dyes in the decorative layer.

### Object

Against this background, the task of the invention is therefore to provide an artificial leather which is easier to produce and which can be produced in a more environmentally friendly and/or sustainable manner than the known natural and/or artificial leathers, which is at least partially biodegradable and which can be applied in as wide a field as possible.

### DESCRIPTION OF THE INVENTION

According to the invention, this task is solved by a layer composite for use as an imitation leather, which has the following layers or consists thereof:
a) a carrier layer having or consisting of textile material, and
b) a decorative layer,
   wherein
the decorative layer comprises or consists of the following components:
i. a binder,
ii. a filling material comprising an inorganic salt and/or lignin and/or a combination of plant leaf material and a gum material, preferably starch gum, and
iii. a humectant.

In contrast to the known leather substitutes, in particular the layer composite known from EP 3 710 631 A1, the layer composite according to the invention does not require a protective cover layer. This is made possible by a decorative layer that has sufficient stability and durability. In the layer composite according to the invention, the decorative layer therefore not only has visual and tactile functions, but is also essential for the structural stability and flexibility of the layer composite.

For this purpose, the decorative layer has a total of three components, a binder, a filler material and a humectant. The binder serves as a matrix material to hold the filler material, which gives the decorative layer its mechanical stability. By embedding the filling material in the binder, a flexible, i.e. elastically pullable and bendable, but stable layer is formed. The third component, the humectant, prevents the decorative layer from drying out. The decorative layer may also have several of the respective components, e.g. several different humectants. In a preferred embodiment, the layer composite may further have multiple decorative and/or carrier layers. By combining several decorative and/or carrier layers, optical and structural properties of the layer composite can be adapted even more individually.

In particular, the mechanical properties of the decorative layer and thus of the layer composite can be controlled via the properties of the filler material, especially its hardness. For example, with an inorganic salt as a filler, a significantly stronger material can usually be obtained, whereas a plant leaf material as a filler tends to lead to soft, i.e. highly flexible, layer composites. Lignin as a filler also leads to a comparatively firm decorative layer. Depending on the filler material, however, the decorative layer not only gives the layer composite a good grip, an attractive appearance and sufficient stability, but also creates a pleasant scent. This effect can be enhanced in particular by the fact that the individual layers of the composite are partially or completely needled and not glued and/or pressed. In this way, the layer composite has an increased permeability.

By using various inorganic salts or plant leaf materials or mixtures of the aforementioned, possibly in combination with lignin, the layer composite according to the invention can be used to reproduce almost all conceivable leather colours. The layered composite according to the invention can therefore be used in a variety of different applications.

The binder serves as a matrix material for the filling material. It is therefore present in the decorative layer in its set form and thus enables the filling material to be firmly incorporated into the decorative layer. Particularly preferably, the binder is an organic binder. Particularly preferably, it is a—preferably organic—polymeric binder such as, for example, a crosslinked or partially crosslinked polymer. Through the combination of binder and filler, a decorative layer with sufficient stability can be obtained, which is at the same time (elastically) deformable. The layer composite also resembles a leather material in its other properties such as friction resistance and wear behaviour. In order to maintain these properties, achieved in particular through the mixture of filler material and binder, over a longer period of time, the decorative layer must have a humectant. A humectant is an additive that prevents the decorative layer from drying out by binding water to it and/or attracting moisture from the air. This preserves the elastic deformability.

According to the invention, “plant leaf material” means whole or comminuted untreated or treated leaves, in particular leaf dust. Treated leaves” are understood to be those plant leaves or comminuted portions thereof which have been preserved by fermentation, chemical treatment, in particular with alcohols, or by drying. In a preferred embodiment, the plant leaf material is fermented, i.e. it has been subjected to a fermentation process which has brought the dried leaves to a state suitable for storage and consumption.

Alternatively or additionally, the plant leaf material may be chemically treated prior to use in the decorative layer, preferably this is done with a mixture of water and a polyhydric alcohol such as glycerol. This is particularly advantageous when the plant leaf material comprises or consists of whole leaves or sections of leaves. This gives the plant leaf material elastic deformability and increased breaking strength, in particular increased tensile strength and bending strength. Furthermore, it has been found that the plant leaf material can continue to undergo a maturing process even in the layer composite, which improves the deformability and fracture strength of the material. The maturing process has a duration of at least one week, preferably two weeks, more preferably one month and most preferably two months. An improvement of the properties by the maturing process is particularly given if an optional cover layer has or consists of a wax material.

If the filling material of the decorative layer comprises a plant leaf material, then—in contrast to embodiments in which an inorganic salt or lignin is used as the filling material—a rubber material must also be a component of the filling material. This is the only way to obtain a sufficiently stable but flexible decorative layer that does not need to be protected with an additional cover layer. A gum material is understood to comprise heteropolysaccharides and polysaccharides, which form highly viscous and sticky solutions with a solvent such as water, which can harden elastically and thus give the decorative layer with plant leaf material a stable but flexible structure. Particularly preferably, the gum material is starch gum (dextrin).

Where the filler material of the decorative layer is an inorganic salt or lignin, in a preferred embodiment the decorative layer may further have a gum material.

In a preferred embodiment, the filling material comprises an inorganic salt and/or lignin and/or a combination of plant leaf material and a gum material, preferably starch gum. The combination of plant leaf material and a gum material is preferably introduced as a mixture, particularly preferably as a homogeneous mixture, as a filling material into the decorative layer during its manufacture. In another preferred embodiment, the plant leaf material and the rubber material are introduced as separate components during the manufacture of the decorative layer.

In a preferred embodiment of the invention, when the filler material of the decorative layer comprises a plant leaf material, it is substantially free of wood fibres. In the context of the present invention, this means that the proportion of wood fibres, for example material from wood chips, sawdust, wood trunks and branches is less than 5 wt %, preferably less than 1 wt %, even more preferably less than 0.5 wt % and most preferably less than 0.1 wt %. Corresponding wood fibres can negatively affect the visual and haptic properties of the material layer composite.

Particularly preferably, the plant leaf material is selected from the group consisting of rose leaves, vine leaves, cherry laurel leaves and tobacco. Particularly preferred is the plant leaf material tobacco.

Tobacco offers several advantages over other plant leaf materials. It has a very good and yearround availability as a raw material. Due to the declining demand for tobacco, there is usually excess production capacity that can be purchased at a low price. Furthermore, tobacco has a high content of natural alkaloids, especially nicotine, which act as insecticides. This can keep mites and other pests away from the layer composite and obtain a particularly durable imitation leather. Furthermore, tobacco leaves have a particularly high flexibility and tear resistance, especially after treatment with a mixture of water and a polyhydric alcohol. In addition to the optical properties, the natural scent also speaks in favour of using tobacco as a decorative layer in an imitation leather. These advantageous properties are particularly pronounced in fermented tobacco.

In a preferred embodiment, the plant leaf material of the decorative layer is finely ground tobacco and/or tobacco dust and/or tobacco cuttings, wherein the plant leaf material is preferably bound in the decorative layer by a polysaccharide, i.e. the binder is a polysaccharide. In a preferred embodiment of the invention, the polysaccharide is dissolved or suspended in a solvent or dispersant having or consisting of a humectant such as a polyhydric alcohol such as glycerol prior to the formation of the decorative layer.

In another preferred embodiment, plant leaves and/or partial sections and/or panicles are the plant leaf material of the decorative layer. Such a decorative layer gives the layer composite a particularly natural and noble appearance and can therefore also be referred to as a finishing layer. Similar to animal crocodile or snake leather, such a decorative layer creates a unique, always differently structured and lively appearance of the layer composite. In order to achieve particularly good visual and tactile properties of the composite, in a preferred embodiment of the invention the sheets are laid in an overlapping manner. This creates a decorative layer with sections of different thickness. These “irregularities” of the layer composite create the impression of a particularly natural imitation leather for the user.

According to the invention, “inorganic salt” is understood to be an inorganic, crystalline substance which is composed of positively charged ions (cations) and negatively charged ions (anions). Ionic bonds exist between these ions. As a solid, these together form an ion lattice that is responsible for the strength of the material. The inorganic salt is preferably a mineral compound, i.e. a materially uniform, natural and inorganic component of the earth. The term inorganic salts also includes coordination compounds that are composed of one or more central particles and one or more ligands. By using minerals, the proportion of natural components of the layer composite can be further increased.

“Lignin” is the collective name for a group of preferably three-dimensionally linked phenolic macromolecules. Lignin, like the inorganic salts of the decorative layer, can impart a particularly pronounced strength to the decorative layer.

In a preferred embodiment, the filler material or binder is coloured with a synthetic or preferably natural colourant. This allows the optical properties of various types of animal leather to be imitated. In a particularly preferred embodiment of the invention, the colouring agent is partially or completely food safe and/or consists of substances which can be returned to biological cycles as biological nutrients or continuously kept in technical cycles as technical nutrients (cradle-to-cradle certification).

In a preferred embodiment, the thickness of the decorative layer is 0.1 to 10 mm, more preferably 0.1 to 5 mm, particularly preferably 0.1 to 2 mm, most preferably 0.2 to 1 mm.

In a preferred embodiment, the basis weight (grammage) of the decorative layer is 100 to 3000 g/m2, more preferably 400 to 2500 g/m², particularly preferably 600 to 1800 g/m², most preferably 700 to 1200 m². Due to a low weight per unit area, particularly light layer composites can be produced.

The layer composite is stable, lighter than animal leather, scratch-resistant and water-repellent. It is also characterised by its rub fastness, heat resistance and excellent wear behaviour. Especially the versions with an inorganic salt as filling material are characterised by a high and lasting light fastness. Due to the different and combinable fillers (plant leaf material and rubber material, inorganic salt and/or lignin), the properties of the layer composite can be adapted to the specific application. For example, a very lightfast and bright layer composite can be obtained by using titanium dioxide as a filler. Furthermore, due to the two-layer structure, the layer composite is much easier and faster to produce than the imitation leather known from the prior art. As a rule, the layer composite can already be used after application and drying of the decorative layer on the carrier layer. A large part of the layer composite, in some embodiments even the entire layer composite, are furthermore recyclable, as the materials used are degradable and/or of natural origin.

In a preferred embodiment, the weight percentage of the filler material in the decorative layer is at least 10 wt %, more preferably at least 15 wt %, even more preferably at least 20 wt %, even considerably more preferably at least 25 wt %, even considerably more preferably at least 30 wt %, and most preferably at least 40 wt %, but preferably also ≤60 wt %. A high proportion of filler material improves the mechanical properties of the decorative layer, in particular its stability.

The decorative layer of the layer composite may comprise one or more humectants. The humectant prevents the decorative layer from drying out and thus ensures that the decorative layer of the layer composite remains permanently flexible. This is particularly necessary in view of the fact that the layer composite according to the invention does not necessarily require a cover layer that protects the decorative layer from drying out.

In a preferred embodiment of the invention, the humectant is selected from glycerol, polydextrose, sorbitol, polyhydric alcohols and polyalcohols such as 1,2-propanediol, glycol, alditols, aloe vera gel, honey, lithium chloride, molasses, urea, xylitol, hydroxycarboxylic acids, hyaluronic acids and salts or esters of hyaluronic acid, triacetin, cellulose powder, quillaja extract, urea, pantolactone or mixtures of the above.

In a preferred embodiment, the proportion by weight of the humectant in the decorative layer is at least 15 wt %, more preferably at least 20 wt %, even more preferably at least 25 wt %, still more preferably at least 30 wt %, still considerably more preferably at least 35 wt %, still considerably more preferably at least 40 wt % and most preferably at least 45 wt %, but preferably also ≤60 wt %. A high proportion of humectant improves the elasticity of the decorative layer and thereby prevents buckling/breaking.

The decorative layer of the layer composite may comprise one or more inorganic salts as filler material.

In a preferred embodiment of the invention, the one or more inorganic salts are selected from halides, in particular chlorides and bromides, oxides, hydroxides, sulphides, carbonates, sulphates, phosphates, nitrates and mixtures of the foregoing. Chlorides, bromides, phosphates and sulphates are particularly preferred. In a preferred embodiment of the invention, the inorganic salt is pH neutral, i.e. a 0.1 molar solution of the salt in water has a pH in the range of 5-9, preferably 6-8. In this way, impairment of the other components of the layer composite can be avoided and a more durable layer composite can be obtained.

In a preferred embodiment of the invention, the inorganic salt comprises a metallic cation, preferably selected from the main metallic group elements, particularly preferably alkali metals and alkaline earth metals. Particularly preferably, the inorganic salt is free of heavy metals, i.e. the proportion of metals with a density 5.0 g/cm³ in the inorganic salt is ≤1 wt %, preferably ≤0.1 wt %. This ensures that the layer composite according to the invention is particularly sustainable and environmentally compatible. Particularly preferably, the inorganic salt is a mineral, especially preferably chalk, kaolin, kaolinite, phyllosilicates, especially clay minerals, halloysite, marble, especially marble powder, iron oxide, especially iron(II) oxide and iron(III) oxide, titanium oxide or zeolite. Zeolites are particularly preferred because of their adsorption capacity, which can be used, for example, to absorb odours.

If the filling material comprises plant material, the filling material must further comprise a gum material to ensure that a stable yet flexible decorative layer is obtained.

The rubber material is preferably selected from gum arabic, tragacanth, vulcanisates of natural and synthetic rubbers, karaya rubber and starch rubber.

The decorative layer further comprises at least one binder, i.e. a film-forming material capable of adhering to the carrier layer and in which the filler material can be bound, so that a decorative layer with filler material contained therein is formed on the carrier material. The binder also imparts a degree of flexibility to the material which is advantageous in use as an imitation leather. The binder may be a synthetic polymeric material. However, in order to increase the biocompatibility and sustainability of the layer composite, the binder is preferably a biopolymer, which preferably consists of or at least comprises biogenic, i.e. renewable, raw materials and/or is biodegradable. Particularly preferably, the binder is a gelling agent based on a plant or animal protein or a binder based on a polysaccharide, in particular a polysaccharide, such as a galactose polymer. Particularly preferred is the gelling agent selected from the group consisting of agar-agar, chitosan, pectin and xanthan, natural and synthetic resins, gelatin, alginic acid and alginate, cellulose, carrageenan, furcellaran, locust bean gum, guar gum, tragacanth, tara gum, gellan, cellulose ether, modified starch, glue or mixtures of the aforementioned.

Particularly preferably, the binder and/or the decorative layer and/or the layer composite are substantially free of polyurethane or polyvinyl chloride, and particularly strongly preferably free of polyurethane and polyvinyl chloride. This is preferred because these polymers release partially toxic compounds during their decomposition. This makes it possible to obtain a particularly ecologically safe material. In this context, substantially free means that the proportion by weight of polyurethane and/or polyvinyl chloride in the total weight of the binder and/or the decorative layer and/or the layer composite is ≤20 wt %, preferably ≤10 wt %, more preferably ≤5 wt %, more preferably ≤2 wt %, even more preferably ≤1 wt %, and most preferably ≤0.5 wt %.

In a preferred embodiment, the weight percentage of binder in the decorative layer is at least 10 wt %, more preferably at least 15 wt %, even more preferably at least 20 wt %, even significantly more preferably at least 25 wt %, even significantly more preferably at least 30 wt %, and most preferably at least 40 wt %, but also preferably ≤60 wt %. A high proportion of binder is conducive to obtaining a stable decorative layer in which the filler material can be uniformly distributed.

Preferably, the weight ratio of binder to filler material in the decorative layer is in the range of 1:10 to 10:1, preferably 1:2 to 10:1, more preferably 1:1 to 5:1 or 1:2 to 2:1, even more preferably 1:1 to 3:1 and most preferably 1:1 to 2:1.

Preferably, the weight ratio of binder to humectant in the decorative layer is in the range of 1:10 to 10:1, preferably 1:2 to 10:1, more preferably 1:1 to 5:1 or 1:2 to 2:1, even more preferably 1:1 to 3:1 or 1:2 to 1:1 and most preferably 1:1 to 2:1.

In a preferred embodiment, the proportion by weight of water in the decorative layer and/or the layer composite is at least 1 wt %, more preferably at least 2 wt %, still considerably more preferably at least 5 wt %, still more preferably at least 10 wt % and most preferably at least 15 wt %, but also preferably ≤30 wt %.

The carrier layer determines the structural strength of the composite and ensures good processability, in particular when the layer composite is processed by sewing.

In a preferred embodiment, the textile carrier layer has or consists of a material selected from the group consisting of nonwoven fabrics, woven fabrics, knitted fabrics, braids or mixtures of the aforementioned.

Nonwoven fabrics, woven fabrics, knitted fabrics, braids or mixtures of the aforementioned are textile materials which are composed of fibres but differ from one another in the arrangement of the fibres.

According to the invention, nonwoven is understood to mean a structure made up of fibres of limited length, continuous fibres (filaments) or chopped yarns of any kind and any origin, which have been joined together in some way to form a fibre layer and connected to each other in some way. This excludes the interlacing or intertwining of yarns, as occurs in weaving, knitting, lace-making, braiding and the manufacture of tufted products. This definition corresponds to the standard DIN EN ISO 9092. According to the invention, the term nonwoven also includes felting fabrics. However, films and papers do not belong to nonwovens.

Preferably, the nonwovens are anisotropic nonwovens, i.e. those with fibre orientation. In this way, an anisotropic mechanical behaviour of the layer composite can be produced, whereby its tear strength is increased.

According to the invention, woven fabric is understood to be a textile fabric consisting of two thread systems, warp (warp threads) and weft (weft threads), which cross each other in a pattern as seen on the fabric surface at an angle of exactly or approximately 90°. Each of the two systems can be made up of several warp or weft types (e.g. ground, pile and filling warp; ground, binding and filling weft). The warp threads run in the longitudinal direction of the fabric, parallel to the fabric edge, and the weft threads run in the transverse direction, parallel to the fabric edge. The threads are connected to the fabric mainly by friction. In order for a fabric to be sufficiently resistant to shearing, the warp and weft threads usually have to be woven relatively tightly. Therefore, with a few exceptions, the fabrics also have a closed fabric appearance. This definition corresponds to the standard DIN 61100, part 1.

According to the invention, the terms woven and nonwoven also include textile materials which have been tufted. Tufting is a process in which yarns are anchored in a woven or nonwoven fabric by a machine operated by compressed air and/or electricity.

According to the invention, knitted fabrics are understood to be textile fabrics which are produced from thread systems by stitch formation. This includes both crocheted and knitted fabrics.

For the purposes of the invention, braiding is understood to mean the regular interlacing of several strands of flexible material. The difference with weaving is that in braiding the threads are not fed at right angles to the main direction of the product.

The fibres of the nonwoven fabrics, woven fabrics, knitted fabrics, braids or mixtures thereof may be natural fibres, chemical fibres or mixtures of the aforementioned.

Preferably, the fibres are of plant or animal origin or chemical fibres made from natural polymers or polymers based on natural raw materials. In this way, the proportion of natural components of the layer composite and thus its sustainability and biodegradability can be improved accordingly.

Preferably, the natural fibres are selected from the group consisting of seed fibres, bast fibres, leaf fibres and animal fibres. Particularly preferably, these are selected from the group consisting of cotton, animal wool, animal hair, silk, kapok, acon, poplar fluff, bamboo fibre, fibre nettle, hemp, hemp nettle, jute, urena, linen, ramie, kenaf, roselle, sunns, abutilon, pung, castor, sisal, abaca, curaua, fibe, xtle fibre, arenga, afrik, hequen, fique, phormium, alfa, maguey, yucca, pita, coir, broom, hop, bulrush and raffia.

Preferably, chemical fibres are selected from natural polymers or polymers based on natural raw materials. Particularly preferably, these are selected from the group consisting of viscose, modal, lyocell, curpo, cellulose acetates, protein fibres such as casein fibres, polylactides, alginates, chitin, bio-based polyamides, polyesters and polyisoprenes.

In another embodiment, the chemical fibres are made of synthetic polymers selected from the group consisting of polyesters such as PET or PBT, polyamide, polyimide, polyamideimide, aramid, poly(metha)acrylates, modyacryl, polytetrafluoroethylene (PTFE), polyethylene, polypropylene, polychloride, PVC, elastane, polystyrene, polycarbonate, polyvinyl alcohol, vinylal, polyphenyl sulphide, melamine, polyurea, polyurethane, polybenzimidazole, polybenzoxal.

In a preferred embodiment, the thickness of the textile carrier layer is 0.1 to 10 mm, more preferably 0.1 to 5 mm, particularly preferably 0.1 to 2 mm, most preferably 0.2 to 1 mm.

In a preferred embodiment, the basis weight (grammage) of the carrier layer is 50 to 500 g/m², more preferably 65 to 300 g/m², particularly preferably 80-200 g/m², most preferably 90-150 g/m². A low weight per unit area makes it possible to produce particularly lightweight layer composites.

The layer composite can have further layers. Preferably, these are selected from the group consisting of carrier, decorative, adhesive and cover layers. Particularly preferably, the layer composite has one or more additional decorative layers arranged between the carrier layer and an optional cover layer. In a preferred embodiment, the additional layers are arranged on both sides of the carrier layer. Particularly preferred in this context is the symmetrical arrangement of the layers in relation to the carrier layer, for example a layer sequence: 1st cover layer, 1st decorative layer, carrier layer, 2nd decorative layer, 2nd cover layer.

In a preferred embodiment of the invention, the layer composite has only adhesive layers as further layers. In another preferred embodiment, the layer composite has no layers other than carrier and decorative layers.

In a preferred embodiment, the individual thicknesses of these additional layers are 0.1 to 10 mm, more preferably 0.2 to 8 mm, particularly preferably 0.5 to 5 mm, most preferably 0.8 to 3 mm.

In a preferred embodiment, the basis weight (grammage) of the additional layers is 50 to 200 g/m2, more preferably 65 to 300 g/m², particularly preferably 80 to 200 g/m², most preferably 90 to 150 m². A low weight per unit area allows particularly lightweight layer composites to be produced.

In a preferred embodiment, the layer composite may have one or more adhesive layers. The adhesive of the adhesive layers may be chemically curing and/or physically setting.

The adhesive of the adhesive layers is preferably selected from the group consisting of cyanoacrylates, methyl methacrylates, unsaturated polyesters, dispersion adhesives, solvent- or dispersion-containing wet adhesives. dispersion-containing wet adhesives, protein-based adhesives, hot-melt adhesives, plastisols, epoxy adhesives, polyurethane adhesives, silicones, resins, especially phenolic resins, polyimides, polysulphides, poly(meth)acrylates, polyvinyl acetates, rubbers and bismaleimides.

In order to produce the material in the most environmentally friendly way, protein adhesives are particularly preferred.

Preferably, the adhesive is cured by chemical hardening or solidification by cooling. In this way, small quantities of solvents or dispersants can be used or even solvents or dispersants can be dispensed with altogether. This is not only particularly sustainable, as a rule the processing times and the bonding within the layer composite are also better.

In a further advantageous embodiment, the strength, in particular the tensile strength and/or the bending strength, of one, several or all carrier layers and/or optional cover layer and/or optional adhesive layers is greater than that of the at least one decorative layer.

The tensile strength, also tear strength, is the maximum tensile stress that a body can withstand. It can be determined by a tensile test.

The bending tensile strength is the maximum tensile stress that a body can withstand when subjected to bending. It can be determined by means of a 3- or 4-point bending tensile test.

If, in an advantageous embodiment, the strength, in particular the tensile strength and/or bending tensile strength, of one, several or all carrier layers and/or optional cover layers and/or optional adhesive layers is greater than that of the at least one decorative layer, the carrier and/or optional cover and adhesive layers can take over the resulting stresses when subjected to mechanical stress, so that the at least one decorative layer does not break or only breaks under higher stress, as a result of which unfavourable cracks would occur in the layer determining the appearance.

Particularly preferably, the decorative layer, preferably even the entire layer composite, has a modulus of elasticity (tensile) of ≤3 GPa, more preferably ≤2 GPa, even more preferably ≤1.5 GPa, still more preferably ≤1 GPa and most preferably ≤0.5 GPa.

An optional cover layer has or consists of a plastic, wax or protein material or a combination of rubber material and binder or a mixture of the foregoing. It essentially serves to protect the underlying decorative layer from external influences such as moisture, abrasion and/or radiation. It therefore preferably covers at least 50% of the surface of the underlying layer, preferably more than 70%, more preferably more than 80% and most preferably more than 90%.

In the case of very high requirements for strength, water resistance and abrasion resistance, plastic materials are preferred. According to the invention, this means all materials consisting of macromolecules of natural or synthetic origin.

In a preferred embodiment, the plastic material has or consists of a material selected from the group consisting of polypropylene (PP), polyethylene (PE), polyvinyl butyral (PVB), polyamide (PA), polyester, in particular polybutylene terephthalate (PBT) and polyethylene terephthalate (PET), polyurethane (PU), polyethylene oxides, polyphenylene oxides, thermoplastic polyurethanes (TPU), polyurea, polyacetal, polyacrylate, poly(meth)acrylates, polyoxymethylene (POM), polyvinyl acetal, polystyrene (PS), acryl-butadiene-styrene (ABS), acrylonitrile-styrene-acrylic ester (ASA), polysaccharides, especially pectin and agar-agar, polycarbonates, polyethersulfones, polysulfonates, polytetrafluoroethylene (PTFE), polyurea, formaldehyde resins, melamine resins, polyetherketone, polyvinyl chloride, polylactide, polysiloxane, phenolic resins, epoxy resins, poly(imide), bismaleimide triazine, thermoplastic po-lyurethane, ethylene-vinyl acetate copolymer (EVA), polylactide (PLA), polyhydrobutyric acid (PHB), copolymers and/or mixtures of the aforementioned polymers. PE, PET, PU and PA are particularly preferred.

Preferably, the plastic is used in the form of a film. According to the invention, this is understood to mean a sheet-like plastic material produced in webs with a layer thickness <5 mm, preferably <1 mm.

In the case of high requirements for haptics, odour and appearance, a cover layer of protein material or wax is preferred.

According to the invention, wax is understood to be natural or artificially obtained substances which are kneadable at 20° C., solid to brittle-hard, have a coarse to fine crystalline structure, are translucent to opaque in colour but not glassy, melt above 40° C. without decomposition, are slightly liquid just above the melting point, i.e. have little viscosity, have a strongly temperature-dependent consistency and solubility, and can be polished under light pressure. This corresponds to the definition according to Römpp Chemie Lexikon, 10th edition, 1999 Georg Thieme Verlag.

Waxes can be distinguished between natural waxes, chemically modified waxes and synthetic waxes. In a preferred embodiment of the invention, the wax material is selected from the group of natural waxes, particularly preferably from the group of plant waxes, in particular, candelilla wax, carnauba wax, Japan wax, esparto grass wax, cork wax, guaruma wax, rice germ oil wax, sugar cane wax, ouricury wax, montan wax.

In another preferred embodiment, the natural wax is selected from the group consisting of animal waxes and mineral waxes, in particular from the group consisting of beeswax, shellac wax, spermaceti, lanolin (wool wax), brushing fat, ceresin, ozokerite (earth wax).

Natural waxes offer the advantage that they are not petroleum-based and thus contribute to the sustainability and biodegradability of the layer composite.

In another embodiment, the wax is selected from the group consisting of chemically modified waxes or synthetic waxes, in particular from the group selected from montan ester waxes, sasol waxes, paraffins, hydrogenated jojoba waxes, polyalkylene waxes, polyethylene glycol waxes.

In a further preferred embodiment, the optional cover layer of the layer composite has or consists of a protein material. Preferably, these are proteins of plant origin. Here, proteins contained in lupins, soybeans, peas, linseeds, wheat, maize and/or rapeseed are particularly preferred.

In a further embodiment, the proteins are of animal origin, with gelatin, casein, whey proteins and/or derivatives thereof being particularly preferred.

The advantage of a protein coating layer is that the cost of producing the protein layer is very low and that it is harmless to health. The layer can also be processed without organic solvents, i.e. water-based. It should also be emphasised that the protein cover layer consists of renewable raw materials that are biodegradable as well as self-adhesive or adhesive.

In a preferred embodiment, the thickness of the optional cover layer is 5 μm-1 mm, more preferably 10 μm to 0.5 mm, particularly preferably 20 μm to 0.1 mm, most preferably 50 μm to 0.1 mm.

The optional cover layer—just like the decorative layer—can further have additives such as dyes, UV filters, binders or other fillers. By adding additives and fillers, the properties of the layers can be changed, in particular colour, strength and manufacturing price.

In a preferred embodiment, the cover layer comprises or consists of a combination of a binder, preferably agar-agar, a gum material, preferably dextrin, and a humectant. Such a cover layer gives the layer composite a particularly high scratch resistance. The cover layer can further help to improve the colour fastness of layers placed underneath.

The invention further comprises various uses of the layer composite according to the invention and articles comprising the layer composite according to the invention.

The layer composite is strong, lighter than animal leather, scratch resistant, as well as water repellent. Therefore, it can preferably be used as a material for clothing and fashion accessories. According to the invention, clothing is defined as the totality of all materials which, as an artificial covering, surround the human body in a more or less tight-fitting manner. This also includes headgear, in particular hats and shoes. According to the invention, fashion accessory means accessories for clothing. These are preferably belts, gloves, fans, sunshades or umbrellas, bags, scarves and jewellery, in particular watch straps. All these materials may comprise the layer composite according to the invention.

The layer composite can also be used for coverings and for upholstery for furniture and in particular for automotive equipment. The present invention therefore also relates to coverings and upholstery comprising the layer composite according to the invention. Particularly preferably, this relates to upholstery and coverings for the interior fittings of motor vehicles, in particular the upholstery of seats and dashboards.

In a preferred embodiment, the binder of the decorative layer has a transmission in the visible wavelength range of ≥30%, preferably ≥50%, more preferably ≥70% and most preferably ≥90%. This allows the optical properties of the filling material, e.g. the tobacco or the inorganic salt, to stand out particularly well.

In a further preferred embodiment, the transmission of both the textile carrier layer and the binder of the decorative layer in the visible wavelength range is ≥30%, preferably ≥50%, more preferably ≥60% and most preferably of ≥80%. This makes it possible to obtain a layer composite which can be particularly well backlit and can thus be used in various applications in the lighting field, for example as a lampshade or in the interior of a motor vehicle.

The invention also comprises a method for producing the layer composite, which has the following steps:
A) applying the following components, preferably as a mixture, to a textile carrier layer to obtain a decorative layer disposed on the carrier layer and preferably covering ≥90% of a planar side of the carrier layer:
   i. a binder,
   ii. a filler material comprising an inorganic salt and/or lignin and/or a combination of plant leaf material and a gum material such as starch gum, and
   iii. a humectant,
   iv. optionally: organic or inorganic solvent.
Optionally: drying the layer composite, i.e. removing solvent contained in the layer composite, until weight constancy (i.e. less than 0.1% weight loss per hour when dried at 50° C.) occurs, preferably at a temperature 30° C.

According to the invention, application is understood to mean the establishment of a firm bond between the layers. This can be done, for example, by bonding, curing a layer, needling or 3D printing.

In a preferred embodiment of the invention, a transfer film is used in the manufacturing process.

In a preferred embodiment, an already cured layer such as a cured, i.e. set, decorative layer may be applied to the carrier layer. To produce a cured decorative layer, the above components may preferably be applied as a mixture to a non-adherent substrate to form a continuous layer. After the binder has set, e.g. by physical drying or chemical cross-linking, the resulting decorative layer is removed from the substrate and applied to the carrier layer. The application can be done by applying adhesive to the carrier layer and/or the already cured decorative layer, placing the decorative layer on the carrier layer and pressing the layers together, preferably under pressure. Alternatively and/or additionally, the layers may be needled.

In another preferred embodiment, the binder can be applied to the textile carrier layer in its non-set form, so that it sets after application by physical (e.g. evaporation of a solvent) and/or chemical processes (e.g. cross-linking, polymerisation or oxidation), i.e. solidifies, and a firm but flexible decorative layer is formed. The binder is preferably applied to the textile carrier layer in a solvent, which preferably also comprises the other components, i.e. filler and humectant. The setting of the binder preferably takes place at a temperature 30° C., more preferably 50° C.

The curing of the composition comprising binder, filler material and humectant and the formation of the decorative layer may also take place under the influence of elevated temperatures, pressure and/or radiation.

If the layer composite according to the invention is to have an optional cover layer, then in a particularly preferred embodiment of the process a polyethylene layer can be adhered to the decorative layer in a laminating plant for paper products.

In another embodiment of the invention, a composition yet to be cured may be applied to the decorative layer to form the optional cover layer. For example, one or more waxes may be applied to the decorative layer to cure on the decorative layer.

The curing of the composition and the formation of an optional cover layer may also occur under the influence of elevated temperatures, pressure and/or radiation.

In another embodiment of the invention, the layers are additionally needled. Needling the layers has the advantage that the permeability, for example for gases such as water vapour, can be significantly increased.

Since the carrier layer is usually supplied as a continuous web, the layer composite can be produced in a continuous process, which is a considerable advantage over the discontinuous process used in animal leather production.

Cover layers for screen printing, which are common in the textile sector, have also been successfully tested as an optional cover layer. Particularly preferred in this context are cover layers made from water-based mixing systems for textile printing. These water-based mixing systems have a water-based binder, in particular a synthetic resin dispersion binder, which preferably has a transparency 80% and/or contains further components such as pigments, adhesion promoters or fillers. Water-based mixing systems that are free of organic solvents or dispersants, phthalates, formaldehyde, alkylphenols and alkylphenol ethoxylates are particularly preferred. The water-based mixing systems are preferably label-free, non-toxic and skin-friendly.

After application to the decorative layer, the water-based mixing systems are preferably dried with the addition of heat and then heat-fixed at a temperature of 150-160° C. The fixation can be done with a transfer press, a drying tunnel, a heat gun, an iron, an ironing press or in an oven. The fusing time is 2-3 minutes at the above temperatures.

In a particularly preferred embodiment, the manufacturing process is carried out as shown below. First, the carrier layer is transported by rollers. In a subsequent section, a mixture of non-set binder, filler and humectant is applied to the carrier layer, dried and optionally pressed.

An additional cover layer can also be provided. If the cover layer is a plastic material in the form of a film, this can be adhered by a heated calender.

In a preferred embodiment of the invention, the process has at least one, preferably all, of the following additional process steps:
B) dissolving and/or dispersing the filler material, the binder and the humectant in one or more aqueous solvents and/or dispersants prior to application to the carrier layer,
C) removing the one or more aqueous solvents and/or dispersants after application to the support or cover layer, preferably at elevated temperature and/or reduced pressure, so that the decorative layer is formed.
Optional:
D) needling and/or bonding at least two layers of the layer composite,
E) embossing the decorative layer, preferably with a roller, a calender or a press.

In a preferred embodiment, steps A) to E) are carried out in the order A), B), C), D), E).

By embossing the decorative layer, the surface structure is influenced and thus a layer is obtained which visually comes even closer to a natural leather layer. Such a structuring can furthermore be useful to conceal imperfections in the decorative layer. Such embossing is particularly advantageous when lignin or inorganic salts are used as filling material, as this can break up the usually relatively uniform appearance of the decorative layer.

In a preferred embodiment, the humectant may be the or one of the one or more aqueous solvents and/or dispersants.

In a preferred embodiment of the method in which a combination of plant leaf material and rubber material is used as filler material, adhesive is applied to the plant leaf material and/or the carrier layer before the filler material is applied to the textile carrier layer. In this way, a particularly strong bond between the carrier layer and the decorative layer can be achieved.

In a preferred embodiment of the method, the layers of the composite are pressed under elevated pressure, the pressing being carried out in a transfer press and/or using elevated temperatures.

In a preferred embodiment of the method, the aqueous solvent or dispersant has the binder, which is preferably selected from the group consisting of polysaccharides, in particular agar agar, pectin, xanthan gum, natural and synthetic resins, gelatin, alginate, chitosan, cellulose ether, modified starch, glue or mixtures of the foregoing. Due to the binder, the composition of filler, binder, humectant and solvent has a higher viscosity during this manufacturing process. This makes it easier to apply to the carrier layer. This effect is particularly pronounced if the solvent or dispersant is a mixture of water and a polyhydric alcohol, in particular glycerol.

In a preferred embodiment of the method, the aqueous solvent or dispersant therefore has an alcohol, preferably a polyhydric alcohol such as glycerol, glycol, polyethylene glycol or polyethylene oxide.

### EXAMPLES

The invention will now be further explained with reference to specific embodiments of layer composites according to the invention, an example of manufacture and the attached figures.

In the following embodiments, the layer composite has layers with the materials listed in the respective cells. The layers or the filler material have or consist of the material mentioned in the respective cells.

1. Embodiments with a Combination of Plant Leaf Material and Rubber Material as Filler Material of the Decorative Layer.

The binder in the following layer composites is preferably agar-agar. The humectant is preferably glycerol.

| # | Carrier Layer | Filler material decorative layer |
|---|---|---|
| T1 | Nonwoven | plant leaf material, particularly tobacco, |
| | fabric | and gum material |
| T2 | Nonwoven | plant leaf material, particularly tobacco, |
| | fabric | and gum material |
| T3 | Nonwoven | plant leaf material, particularly tobacco, |
| | fabric | and gum material |
| T4 | Flax nonwoven | plant leaf material, particularly tobacco, |
| | fabric | and gum material |
| T5 | Flax nonwoven | plant leaf material, particularly tobacco, |
| | fabric | and gum material |
| T6 | Flax nonwoven | plant leaf material, particularly tobacco, |
| | fabric | and gum material |
| T7 | Woven fabric | plant leaf material, particularly tobacco, |
| | | and gum material |
| T8 | Woven fabric | plant leaf material, particularly tobacco, |
| | | and gum material |
| T9 | Woven fabric | plant leaf material, particularly tobacco, |
| | | and gum material |
| T10 | Natural fibre | plant leaf material, particularly tobacco, |
| | woven fabric | and gum material |
| T11 | Natural fibre | plant leaf material, particularly tobacco, |
| | woven fabric | and gum material |
| T12 | Natural fibre | plant leaf material, particularly tobacco, |
| | woven fabric | and gum material |
| T13 | Chemical fibre | plant leaf material, particularly tobacco, |
| | woven fabric | and gum material |
| T14 | Chemical fibre | plant leaf material, particularly tobacco, |
| | woven fabric | and gum material |
| T15 | Chemical fibre | plant leaf material, particularly tobacco, |
| | woven fabric | and gum material |
| T16 | Knitted fabric | plant leaf material, particularly tobacco, |
| | | and gum material |
| T17 | Knitted fabric | plant leaf material, particularly tobacco, |
| | | and gum material |
| T18 | Knitted fabric | plant leaf material, particularly tobacco, |
| | | and gum material |
| TD1 | Nonwoven | plant leaf material, particularly |
| | fabric | tobacco, and dextrin |
| TD2 | Nonwoven | plant leaf material, particularly |
| | fabric | tobacco, and dextrin |
| TD3 | Nonwoven | plant leaf material, particularly |
| | fabric | tobacco, and dextrin |
| TD4 | Flax nonwoven | plant leaf material, particularly |
| | fabric | tobacco, and dextrin |
| TD5 | Flax nonwoven | plant leaf material, particularly |
| | fabric | tobacco, and dextrin |
| TD6 | Flax nonwoven | plant leaf material, particularly |
| | fabric | tobacco, and dextrin |
| TD7 | Woven fabric | plant leaf material, particularly |
| | | tobacco, and dextrin |
| TD8 | Woven fabric | plant leaf material, particularly |
| | | tobacco, and dextrin |
| TD9 | Woven fabric | plant leaf material, particularly |
| | | tobacco, and dextrin |
| TD10 | Natural fibre | plant leaf material, particularly |
| | woven fabric | tobacco, and dextrin |
| TD11 | Natural fibre | plant leaf material, particularly |
| | woven fabric | tobacco, and dextrin |
| TD12 | Natural fibre | plant leaf material, particularly |
| | woven fabric | tobacco, and dextrin |
| TD13 | Chemical fibre | plant leaf material, particularly |
| | woven fabric | tobacco, and dextrin |
| TD14 | Chemical fibre | plant leaf material, particularly |
| | woven fabric | tobacco, and dextrin |
| TD15 | Chemical fibre | plant leaf material, particularly |
| | woven fabric | tobacco, and dextrin |
| TD16 | Knitted fabric | plant leaf material, particularly |
| | | tobacco, and dextrin |
| TD17 | Knitted fabric | plant leaf material, particularly |
| | | tobacco, and dextrin |
| TD18 | Knitted fabric | plant leaf material, particularly |
| | | tobacco, and dextrin |

2. Embodiments with Lignin as Filler Material of Decorative Layer

| # | Carrier Layer | Filler material decorative layer |
|---|---|---|
| L1 | Nonwoven fabric | Lignin |
| L2 | Nonwoven fabric | Lignin |
| L3 | Nonwoven fabric | Lignin |
| L4 | Flax nonwoven fabric | Lignin |
| L5 | Flax nonwoven fabric | Lignin |
| L6 | Flax nonwoven fabric | Lignin |
| L7 | Woven fabric | Lignin |
| L8 | Woven fabric | Lignin |
| L9 | Woven fabric | Lignin |
| L10 | Natural fibre woven | Lignin |
| | fabric | |
| L11 | Natural fibre woven | Lignin |
| | fabric | |
| L12 | Natural fibre woven | Lignin |
| | fabric | |
| L13 | Chemical fibre | Lignin |
| | woven fabric | |
| L14 | Chemical fibre | Lignin |
| | woven fabric | |
| L15 | Chemical fibre | Lignin |
| | woven fabric | |
| L16 | Knitted fabric | Lignin |
| L17 | Knitted fabric | Lignin |
| L18 | Knitted fabric | Lignin |

3. Embodiments with Inorganic Salt as Filler Material of Decorative Layer

| # | Carrier Layer | Filler material decorative layer |
|---|---|---|
| M1 | Nonwoven fabric | Chalk |
| M2 | Nonwoven fabric | Chalk |
| M3 | Nonwoven fabric | Chalk |
| M4 | Flax nonwoven | Chalk |
| | fabric | |
| M5 | Flax nonwoven | Chalk |
| | fabric | |
| M6 | Flax nonwoven | Chalk |
| | fabric | |
| M7 | Woven fabric | Chalk |
| M8 | Woven fabric | Chalk |
| M9 | Woven fabric | Chalk |
| M10 | Natural fibre woven | Chalk |
| | fabric | |
| M11 | Natural fibre woven | Chalk |
| | fabric | |
| M12 | Natural fibre woven | Chalk |
| | fabric | |
| M13 | Chemical fibre | Chalk |
| | woven fabric | |
| M14 | Chemical fibre | Chalk |
| | woven fabric | |
| M15 | Chemical fibre | Chalk |
| | woven fabric | |
| M16 | Knitted fabric | Chalk |
| M17 | Knitted fabric | Chalk |
| M18 | Knitted fabric | Chalk |
| M19 | Nonwoven fabric | Titanium dioxide |
| M20 | Nonwoven fabric | Titanium dioxide |
| M21 | Nonwoven fabric | Titanium dioxide |
| M22 | Flax nonwoven | Titanium dioxide |
| | fabric | |
| M23 | Flax nonwoven | Titanium dioxide |
| | fabric | |
| M24 | Flax nonwoven | Titanium dioxide |
| | fabric | |
| M25 | Woven fabric | Titanium dioxide |
| M26 | Woven fabric | Titanium dioxide |
| M27 | Woven fabric | Titanium dioxide |
| M28 | Natural fibre woven | Titanium dioxide |
| | fabric | |
| M29 | Natural fibre woven | Titanium dioxide |
| | fabric | |
| M30 | Natural fibre woven | Titanium dioxide |
| | fabric | |
| M31 | Chemical fibre | Titanium dioxide |
| | woven fabric | |
| M32 | Chemical fibre | Titanium dioxide |
| | woven fabric | |
| M33 | Chemical fibre | Titanium dioxide |
| | woven fabric | |
| M34 | Knitted fabric | Titanium dioxide |
| M35 | Knitted fabric | Titanium dioxide |
| M36 | Knitted fabric | Titanium dioxide |
| M37 | Woven fabric | Marble |
| M38 | Woven fabric | Marble |
| M39 | Woven fabric | Marble |
| M40 | Woven fabric | Marble |
| M41 | Woven fabric | Marble |
| M42 | Woven fabric | Marble |
| M43 | Knitted fabric | Marble |
| M44 | Knitted fabric | Marble |
| M45 | Knitted fabric | Marble |
| M46 | Natural fibre woven | Marble |
| | fabric | |
| M47 | Natural fibre woven | Marble |
| | fabric | |
| M48 | Natural fibre woven | Marble |
| | fabric | |
| M49 | Nonwoven fabric | Marble |
| M50 | Nonwoven fabric | Marble |
| M51 | Nonwoven fabric | Marble |
| M52 | Flax nonwoven fabric | Marble |
| M53 | Flax nonwoven fabric | Marble |
| M54 | Flax nonwoven fabric | Marble |

4. Embodiments with Different Decorative Layers

The binder in the following layer composites is preferably agar-agar. The humectant is preferably glycerol.

| # | Carrier Layer | Filler material decorative layer |
|---|---|---|
| D1 | Flax nonwoven fabric | Rose leaves and dextrin |
| D2 | Woven fabric | Rose leaves and dextrin |
| D3 | Knitted fabric | Rose leaves and dextrin |
| D4 | Flax nonwoven fabric | Vine leaves and dextrin |
| D5 | Woven fabric | Vine leaves and dextrin |
| D6 | Knitted fabric | Vine leaves and dextrin |
| D7 | Flax nonwoven fabric | Rose leaves and dextrin |
| D8 | Woven fabric | Rose leaves and dextrin |
| D9 | Knitted fabric | Rose leaves and dextrin |
| D10 | Flax nonwoven fabric | Vine leaves and dextrin |
| D11 | Woven fabric | Vine leaves and dextrin |
| D12 | Knitted fabric | Vine leaves and dextrin |
| D13 | Flax nonwoven fabric | Rose leaves and dextrin |
| D14 | Woven fabric | Rose leaves and dextrin |
| D15 | Knitted fabric | Rose leaves and dextrin |
| D16 | Flax nonwoven fabric | Vine leaves and dextrin |
| D17 | Woven fabric | Vine leaves and dextrin |
| D18 | Knitted fabric | Vine leaves and dextrin |

5. Embodiments with Additional Layers

The binder in the following layer composites is preferably agar-agar. The humectant is preferably glycerol.

| | | | Filler | |
|---|---|---|---|---|
| | | Filler | material | |
| | | material | additional | |
| | Carrier | decorative | decorative | |
| # | Layer | layer | layer | Cover layer |
| F1 | Flax | Plant leaf | Tobacco | PE/PP/PET/PU/PA/Agar |
| | nonwoven | material and | leave and | -Agar+Dextrin+Humec- |
| | fabric | dextrin | dextrin | tant |
| F2 | Woven | Plant leaf | Tobacco | PE/PP/PET/PU/PA/Agar |
| | fabric | material and | leave and | -Agar+Dextrin+Humec- |
| | | dextrin | dextrin | tant |
| F3 | Knitted | Plant leaf | Tobacco | PE/PP/PET/PU/PA/Agar |
| | fabric | material and | leave and | -Agar+Dextrin+Humec- |
| | | dextrin | dextrin | tant |
| F4 | Flax | Rose leaves | Tobacco | PE/PP/PET/PU/PA/Agar |
| | nonwoven | and dextrin | leave and | -Agar+Dextrin+Humec- |
| | fabric | | dextrin | tant |
| F5 | Woven | Rose leaves | Tobacco | PE/PP/PET/PU/PA/Agar |
| | fabric | and dextrin | leave and | -Agar+Dextrin+Humec- |
| | | | dextrin | tant |
| F6 | Knitted | Rose leaves | Tobacco | PE/PP/PET/PU/PA/Agar |
| | fabric | and dextrin | leave and | -Agar+Dextrin+Humec- |
| | | | dextrin | tant |
| F7 | Flax | Plant leaf | Tobacco | Wax |
| | nonwoven | material and | leave and | |
| | fabric | dextrin | dextrin | |
| F8 | Woven | Plant leaf | Tobacco | Wax |
| | fabric | material and | leave and | |
| | | dextrin | dextrin | |
| F10 | Knitted | Plant leaf | Tobacco | Wax |
| | fabric | material and | leave and | |
| | | dextrin | dextrin | |
| F11 | Flax | Rose leaves | Tobacco | Wax |
| | nonwoven | and dextrin | leave and | |
| | fabric | | dextrin | |
| F12 | Woven | Rose leaves | Tobacco | Wax |
| | fabric | and dextrin | leave and | |
| | | | dextrin | |
| F13 | Knitted | Rose leaves | Tobacco | Wax |
| | fabric | and dextrin | leave and | |
| | | | dextrin | |
| F14 | Flax | Plant leaf | Tobacco | Protein material |
| | nonwoven | material and | leave and | |
| | fabric | dextrin | dextrin | |
| F15 | Woven | Plant leaf | Tobacco | Protein material |
| | fabric | material and | leave and | |
| | | dextrin | dextrin | |
| F16 | Knitted | Plant leaf | Tobacco | Protein material |
| | fabric | material and | leave and | |
| | | dextrin | dextrin | |
| F17 | Flax | Rose leaves | Tobacco | Protein material |
| | nonwoven | and dextrin | leave and | |
| | fabric | | dextrin | |
| F18 | Woven | Rose leaves | Tobacco | Protein material |
| | fabric | and dextrin | leave and | |
| | | | dextrin | |
| F19 | Knitted | Rose leaves | Tobacco | Protein material |
| | fabric | and dextrin | leave and | |
| | | | dextrin | |

### Manufacturing Example

50 g rose leaves are dispersed in 50 ml of a mixture of glycerine, dextrin and agar in water and, after decanting the solvent or dispersant, applied to a surface section of a flax nonwoven fabric of grammage 100 g/m². The aqueous solvent or dispersant is removed by air drying at 50° C. to obtain a uniform decorative layer on the carrier layer.

### BRIEF DESCRIPTION OF FIGURES

FIG. 1: Schematic sectional view of a layer composite according to the invention with carrier layer and decorative layer.

FIG. 2: Schematic sectional view of a layer composite according to the invention with carrier layer, decorative layer and cover layer.

FIG. 3: Schematic sectional view of a layer composite according to the invention with carrier layer, decorative layer, 2nd decorative layer and cover layer.

### LIST OF REFERENCE NUMBERS

1 carrier layer
2 decorative layer (inorganic salt as filler material)
3 cover layer
4 2nd cover layer (tobacco and dextrin as filler material)

### DETAILED DESCRIPTION OF FIGURES

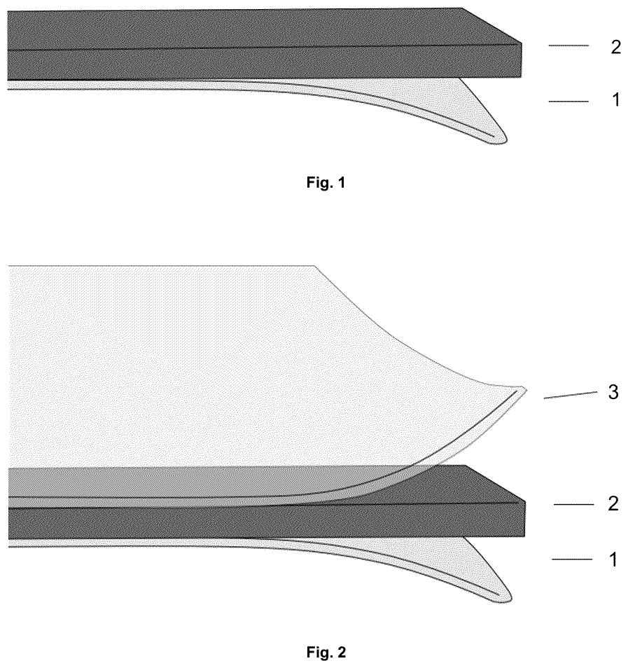

FIG. 1 shows the layered structure of a layer composite according to the invention, which has a carrier layer 1 and a decorative layer 2. The decorative layer 2 comprises an inorganic salt as a filling material.

FIG. 2 shows the layered structure of a layer composite according to the invention, which has a carrier layer 1, a decorative layer 2 and a cover layer 3. The decorative layer 2 comprises an inorganic salt as a filling material.

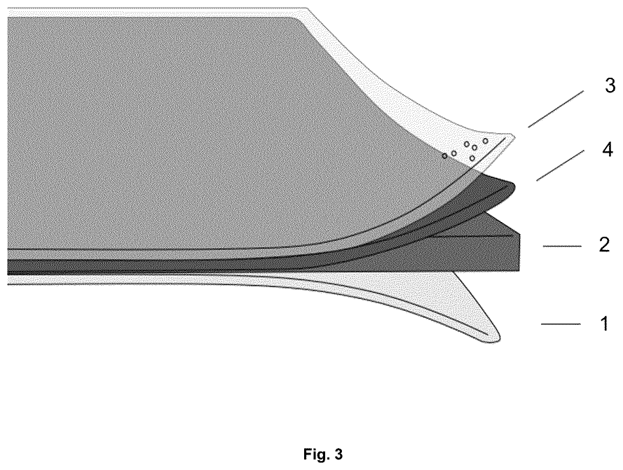

FIG. 3 shows the layered structure of a layer composite according to the invention, which has a carrier layer 1, a decorative layer 2, a cover layer 3 and an additional second decorative layer 4, which is arranged between decorative layer 2 and cover layer 3. The decorative layer 2 comprises an inorganic salt as a filling material. The additional 2nd decorative layer comprises a combination of tobacco and dextrin as filler material. The cover layer 3 is bonded to the second decorative layer by an adhesive (indicated by the droplet).

1: A layer composite for use as an imitation leather, which has the following layers:
a) a carrier layer having textile material, and
b) a decorative layer,
wherein
the decorative layer comprises the following components:
i. a binder,
ii. a filler material comprising an inorganic salt and/or lignin and/or a combination of plant leaf material and a gum material, and
iii. a humectant.

2: The layer composite according to claim 1, wherein the humectant is selected from the group consisting of glycerol, polydextrose, sorbitol, polyhydric alcohols and polyalcohols such as 1,2-propanediol, glycol or alditols, aloe vera gel, honey, lithium chloride, molasses, urea, xylitol, hydroxycarboxylic acids, triacetin, quillaja extract, urea, pantolactone and mixtures of the foregoing.

3: The layer composite according to claim 1, wherein the anorganic salt is selected from the group consisting of iron oxide, titanium dioxide, chalk, kaolin, marble powder and zeolite.

4: The layer composite according to claim 1, wherein the gum material is selected from gum arabic, tragacanth, karaya gum and starch gum.

5: The layer composite according to claim 1, wherein the binder is a polysaccharide preferably selected from the group consisting of agar-agar, chitosan, pectin and xanthan, natural and synthetic resins, gelatin, alginate, cellulose ether, modified starch, glue and mixtures of the foregoing.

6: The layer composite according to claim 1, wherein the weight ratio of binder to filler material is in the range of 1:10 to 10:1.

7: The layer composite according to claim 1, wherein the weight ratio of binder to humectant is in the range of 1:10 to 10:1.

8: The layer composite according to claim 1, wherein the carrier layer has a nonwoven, and/or a woven fabric.

9: The layer composite according to claim 1, wherein said layer composite has one or more adhesive layers.

10: A garment comprising the layer composite according to claim 1.

11: A method of manufacturing the layer composite according to claim 1, comprising the following step:
A) applying the following components to a textile carrier layer to obtain a decorative layer disposed on the carrier layer, preferably covering ≥90% of a planar side of the carrier layer:
i. a binder,
ii. a filler material comprising an inorganic salt and/or lignin and/or a combination of plant leaf and gum material such as starch gum, and
iii. a humectant.

12: The method according to claim 11, wherein the method comprises the following additional steps:
B) dissolving and/or dispersing the filler material, the binder and the humectant in one or more aqueous solvents and/or dispersants prior to application to the carrier layer,
C) removing the one or more aqueous solvents and/or dispersants after application to the carrier layer, preferably at elevated temperature and/or reduced pressure, so that the decorative layer is formed, and
optional:
D) Needling and/or bonding of at least two layers of the layer composite.
E) Embossing the decorative layer, preferably with a roller, a calender or a press.
